(19) United States
(12) Patent Application Publication
(10) Pub. No.: US 2007/0070199 A1
(43) Pub. Date: Mar. 29, 2007

(54) Method and apparatus for automatically adjusting monitoring frames based on image variation

(76) Inventor: Hua-Chung Kung, Taipei City (TW)

Correspondence Address: J.C. Patents, Inc., Suite 250, 4 Venture, Irvine, CA, 92618, US

(21) Appl. No.: 11/326,791

(22) Filed: Jan. 5, 2006

(30) Foreign Application Priority Data
Sep. 23, 2005 (TW) 94133046

(51) Int. Cl. H04N 7/18

(52) U.S. Cl. 348/155

(57) ABSTRACT

A method and an apparatus for automatically adjusting monitoring frames based on image variation are disclosed. According to the present invention, a changed block judgment device and a regional image output device are added to an image capturing device. When the image is moving or changing, the corresponding changed blocks are located automatically, and then a focus block is determined. Afterwards, the image within the focus block is output to an image receiving device after the resolution thereof has been adjusted. Therefore, the purpose of automatically adjusting monitoring frame is achieved.

### CROSS-REFERENCE TO RELATED APPLICATION.

This application claims the priority benefit of Taiwan application serial no. 94133046, filed on Sep. 23, 2005. All disclosure of the Taiwan application is incorporated herein by reference.

### BACKGROUND OF THE INVENTION

1. Field of Invention

The present invention relates to a method and an apparatus for automatically adjusting monitoring frames based on image variation. More particularly, the present invention relates to a method and an apparatus applicable to an image monitoring system, which can automatically adjust monitoring frames based on image variation.

2. Description of Related Art

Along with the widespread of Internet networks, various technologies applicable for the networks are evolving quickly. Recently, the function of transmitting multimedia files, such as photos, music, and videos, is further developed besides the basic functions such as browsing web pages, receiving/sending emails, and because of the expansion of network bandwidth, the network transmission speed also increases tremendously. Thus, monitoring system for transmitting video images in real-time has been recently developed. With only an image capturing device and an image receiving device, the user can capture monitoring images using a remote image capturing device, and the monitoring images can be transmitted back to the user through the network and displayed in the image receiving device for the user to inspect. Thus, the cost is reduced, and furthermore, a very convenient monitoring channel is provided.

The Republic of China Patent No. 442768 discloses a surveillance system for activation and deactivation based on image variation. The operation flow thereof is illustrated in FIG. 1. Referring to FIG. 1, wherein A₀ represents the image frame captured by the image capturing device when the system starts monitoring, and Aᵢ represents the image frame captured at time i, the processing steps of the system are as follows.

First, in step S110, the image capturing device is activated, and a static image frame is captured and numbered as frame A₀. Next, in step S120, the frame A₀ is divided into multiple pixel units in units of 2*2 (or other numbers) pixels, and the pixel value of a pixel unit is the average of the pixel values of 4 pixels contained in the pixel unit.

In step S130, the bitmap of the next image frame, which is also static, is captured and numbered as frame A₁, and in step S140 the frame A₁ is divided similarly as in step S120.

In step S150, the pixel values of the pixel units of frame A₀ are subtracted from the pixel values of the corresponding pixel units of frame A₁ and the absolute values thereof are obtained so as to find the maximum pixel value difference among all the pixel units of frames A₀ and A₁. If P represents the absolute value of the subtraction of pixel values of the corresponding pixel units betweens frame A₀ and A₁, then the maximum difference R is the maximum difference value among P₁, P₂, . . . , Pₙ (the absolute values of the differences from the 1^{st} pixel unit to the n^{th} pixel unit of frames A₀ and A₁ ), and the method for calculating the maximum difference between the values of G and B is similar to that of R. Accordingly, the maximum pixel value difference between frame A₀ and A₁ can be obtained and stored as MAXᵢ(R,G,B), wherein MAXᵢ(R,G,B) represents the maximum value among the pixel value differences between image frames Aᵢ₋₁, and Aᵢ.

In step S160, the pixel units contained in image frame A₁ are further compared with those of the image frame A₂ captured next, and steps S140 to S160 are repeated until the comparisons between multiple groups (e.g. 10 groups) of image frames have been completed. In step S170, the maximum R, G, and B values are obtained from the 10 groups of MAXᵢ(R,G,B) data and are combined as calibration error (R, G, B) values, which are the error range of the image capturing device. Meanwhile, the image frame Aᵢ is set as a key frame.

Through the processing steps described above, the surveillance system can adjust and revise the signals in the image capturing device by comparing the bitmaps of the captured serial digital images so as to avoid activating the video recording program mistakenly due to the errors produced by the image capturing device.

Even though the conventional technology can detect image variation and determine when to activate the video recording program and when to stop the video recording program based on the extent of the image variation, however, the conventional technology has at least the following disadvantages:

The conventional image monitoring device cannot automatically track image variation and display the image variation in the monitoring screen in real-time.

The conventional image monitoring device requires a rotating structure to turn around the lens, yet there are still dead angles, which may result in an increase of manufacturing cost and unreliability in security.

As a rotating structure is added in the conventional image monitoring device, the electricity consumption will be increased greatly, and the electricity consumption will be considerably huge if a monitoring network is to set up.

Because the rotating structure operates mechanically, malfunctions due to mechanical abrasion may be induced.

### SUMMARY OF THE INVENTION

Accordingly, the present invention is directed to provide a method for automatically adjusting monitoring frames based on image variation, which can locate multiple changed blocks based on the image variation of each unit block by dividing the image into multiple unit blocks, so as to achieve the purpose of monitoring moving frames.

According-to another aspect of the present invention, an apparatus for automatically adjusting monitoring frames based on image variation is provided, which can locate the changed blocks in an image with a changed block judgment device and adjust the region and resolution of the output image with a regional image output device, so as to achieve the purpose of automatically adjusting monitoring frames.

The present invention provides a method for automatically adjusting monitoring frames based on image variation, which captures an image with an image capturing device and sends the image with a predetermined resolution to an image receiving device. The method includes the following steps: first, the image is divided into multiple unit blocks by the image capturing device; next, the image variation of each unit block is calculated respectively and multiple changed blocks is marked by the image capturing device; then, a focus block is selected by the image capturing device to cover the foregoing multiple changed blocks; finally, the resolution of the focus block is adjusted to a predetermined resolution by the image capturing device, and the focus block is output to an image receiving device.

According to the method for automatically adjusting monitoring frames based on image variation in an embodiment of the present invention, the foregoing step of respectively calculating the image variation of each unit block and marking multiple changed blocks includes: first, the average RGB value of each unit block is calculated; then, at intervals of a predetermined time, the differences of the average RGB values of the unit blocks in the two consecutively captured images are compared so as to obtain a R difference, a G difference and a B difference respectively, and the R difference, G difference and B difference are compared with a predetermined R tolerance, G tolerance, and B tolerance, and the unit block is marked as a changed block as described above when any of the R difference, G difference, and B difference is greater than the R tolerance, G tolerance, and B tolerance.

According to the method for automatically adjusting monitoring frames based on image variation in an embodiment of the present invention, the foregoing predetermined resolution is determined according to the network bandwidth for transmitting to the image receiving device.

According to the method for automatically adjusting monitoring frames based on image variation in an embodiment of the present invention, the foregoing image receiving device is a display device.

According to the method for automatically adjusting monitoring frames based on image variation in an embodiment of the present invention, the predetermined resolution is the resolution of the display device.

According to the method for automatically adjusting monitoring frames based on image variation in an embodiment of the present invention, the image receiving device is a recording device.

According to the method for automatically adjusting monitoring frames based on image variation in an embodiment of the present invention, an unchanged row in the focus block is further deleted when selecting the focus block. The unchanged row includes multiple unit blocks arranged in a row in the focus block and does not include any of the aforementioned changed blocks.

According to the method for automatically adjusting monitoring frames based on image variation in an embodiment of the present invention, an unchanged column in the focus block is further deleted when selecting the focus block. The unchanged column includes multiple unit blocks arranged in a column in the focus block and does not include any of the aforementioned changed blocks.

According to the method for automatically adjusting monitoring frames based on image variation in an embodiment of the present invention, an unchanged row and an unchanged column in the focus block are further deleted when selecting the focus block. The unchanged row and the unchanged column respectively include multiple unit blocks arranged in a row and in a column in the focus block and do not include any of the aforementioned changed blocks.

The present invention provides an apparatus for automatically adjusting monitoring frames based on image variation, which includes an image capturing device, an image receiving device, a changed block judgment device, and a regional image output device. Wherein, the image capturing device is used for capturing an image and the image receiving device is used for receiving the image captured by the image capturing device. In addition, the changed block judgment device is disposed in the image capturing device and is used for dividing the image into multiple unit blocks, calculating the image variation of each of the unit blocks respectively, and marking multiple changed blocks. The regional image output device is disposed in the image capturing device and is used for determining a focus block based on the aforementioned multiple changed blocks to cover the aforementioned multiple changed blocks and transmitting the focus block to the image receiving device with a predetermined resolution.

According to the apparatus for automatically adjusting monitoring frames based on image variation in an embodiment of the present invention, the changed block judgment device calculates the average RGB value of each unit block respectively, and at intervals of a predetermined time, compares the differences of the average RGB values of the unit blocks in two consecutively captured images so as to obtain a R difference, a G difference, and a B difference respectively, and compares the R difference, G difference, and B difference with a predetermined R tolerance, G tolerance, and B tolerance respectively, and marks the unit block as a changed block as described above when any of the R difference, G difference, and B difference is greater than the R tolerance, G tolerance, and B tolerance.

According to the apparatus for automatically adjusting monitoring frames based on image variation in an embodiment of the present invention, the regional image output device further deletes an unchanged row in the focus block when determining the focus block. The unchanged row includes multiple unit blocks arranged in a row in the focus block and does not include any of the aforementioned changed blocks.

According to the apparatus for automatically adjusting monitoring frames based on image variation in an embodiment of the present invention, the focus block marking device further deletes an unchanged column in the focus block. The unchanged column includes multiple unit blocks arranged in a column in the focus block and does not include any of the aforementioned changed blocks.

According to the apparatus for automatically adjusting monitoring frames based on image variation in an embodiment of the present invention, the focus block marking device further deletes an unchanged row and an unchanged column in the focus block. The unchanged row and the unchanged column include multiple unit blocks arranged in a row and in a column in the focus block, and the unchanged row and the unchanged column do not include any of the aforementioned changed blocks.

In the present invention, since a changed block judgment device and a regional image output device are disposed in the image capturing device, the corresponding unit blocks can be automatically located when the image is moving or changing, and the image in the focus block can be determined and adjusted, so that the purpose of automatically adjusting monitoring frames can be achieved.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is an operation flowchart of a conventional surveillance system for activation and deactivation based on image variation.

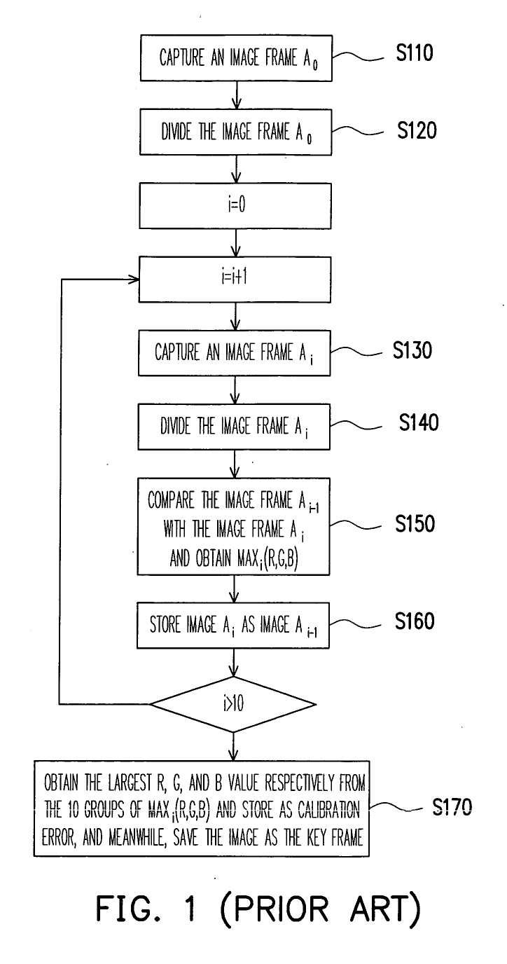

FIG. 2 is a schematic block diagram illustrating an apparatus for automatically adjusting monitoring frames based on image variation according to an embodiment of the present invention.

FIG. 3 is a flowchart illustrating a method for automatically adjusting monitoring frames based on image variation according to an embodiment of the present invention.

FIG. 4 is a diagram illustrating how to calculate a single focus block according to an embodiment of the present invention.

FIG. 5 is a diagram illustrating how to calculate multiple divisional focus blocks according to an embodiment of the present invention.

FIG. 6 illustrates an operation example of the apparatus for automatically adjusting monitoring frames based on image variation according to an embodiment of the present invention.

### DESCRIPTION OF EMBODIMENTS

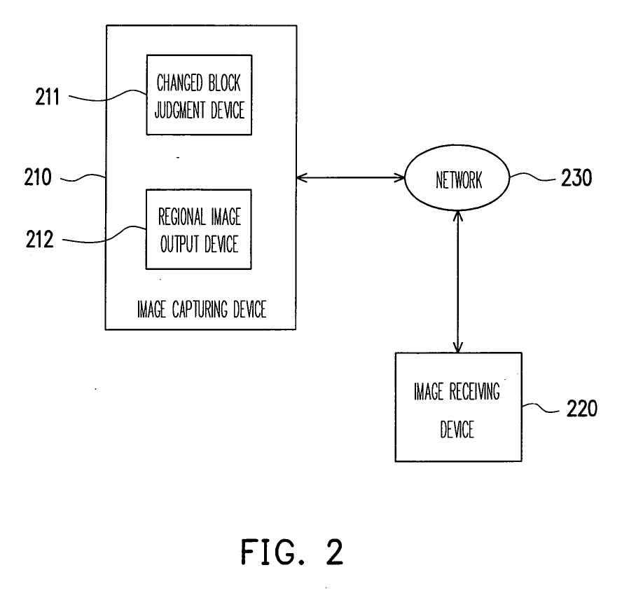

FIG. 2 is a schematic block diagram illustrating an apparatus for automatically adjusting monitoring frames based on image variation according to an embodiment of the present invention. Referring to FIG. 2, in the present embodiment, the region and the resolution of the output image can be adjusted based on the variation of the captured image by disposing a changed block judgment device 211 and a regional image output device 212 in the image capturing device 210 according to the theory of that the resolution of the image capturing device 210 is different from the resolution of the image receiving device 220.

As shown in FIG. 2, in the present embodiment, the image capturing device 210 includes a changed block judgment device 211 and a regional image output device 212, and the image capturing device 210 is connected to the image receiving device 220 through network 230.

The user can view the original image captured by the image capturing device 210 in the image receiving device 220 when the image receiving device 220 is connected to the image capturing device 210 through the network 230. And the changed block judgment device 211 divides the captured image into multiple unit blocks, and calculates and records the average RGB value of each unit block respectively at the same time when the image receiving device 220 starts to capture images.

For example, the resolution of a mega pixel camera is 1280*1024 dpi (Dot per inch), if the size of the divided unit blocks is 32*32 dpi, then there will be 40*32=1280 unit blocks formed, and the average RGB values of these unit blocks can be calculated through the following formulas:
R_{b}(x,y)=Avg(Rₚ(32*x+i,32*y+j),i=0 . . . 31, j=0 . . . 31)
G_{b}(x,y)=Avg(Gₚ(32*x+i,32*y+j),i=0 . . . 31, j=0 . . . 31)
B_{b}(x,y)=Avg(Bₚ(32*x+i,32*y+j),i=0 . . . 31, j=0 . . . 31)

Next, the changed block judgment device 211 obtains images at intervals of a predetermined time (e.g. 0.2 second), calculates the average RGB value of each unit block in the same way, and subtracts the average RGB value of each unit block of the latter captured image from the average RGB value of the corresponding unit block in the previous captured image to obtain a R difference, a G difference, and a B difference respectively.

Here the changed block judgment device 211 compares the R difference, G difference, and B difference with the predetermined R tolerance, G tolerance, and B tolerance respectively, and if any of the R difference, G difference, and B difference is greater than the R tolerance, G tolerance, and B tolerance, the unit block is determined and marked as a changed block.

Similarly, the changed block judgment device 211 can determine whether an image is different from the previous image after a predetermined time, if there is difference determined and there are n unit blocks (n is a positive integer greater than or equal to 1) in the captured image marked as changed blocks, the regional image output device 212 determines a focus block to cover all the changed blocks and transmits the image in the focus block to the image receiving device 220 with a predetermined resolution through the network 230. The foregoing predetermined resolution refers to the resolution of the display screen of the image receiving device 220 or the resolution that the transmission bandwidth of the network 230 can support.

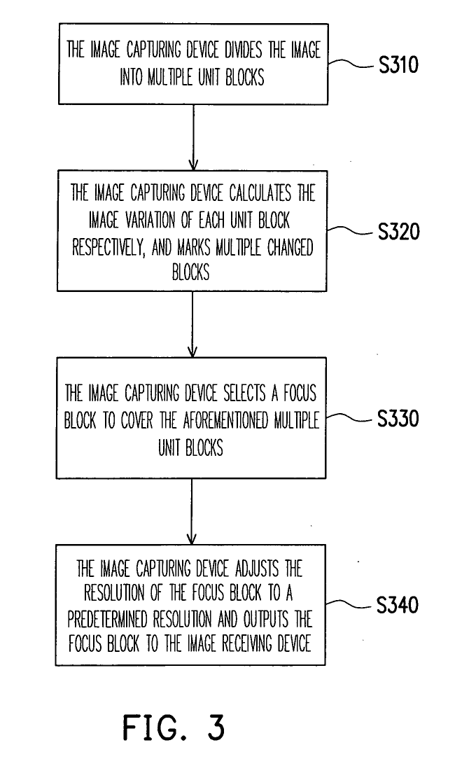

FIG. 3 is a flowchart illustrating the method for automatically adjusting monitoring frames based on image variation according to an embodiment of the present invention. Referring to FIG. 3, in the present embodiment, the image is captured by the image capturing device and sent to the image receiving device with a predetermined resolution so as to automatically adjust the monitoring frames. Wherein, the aforementioned image receiving device may include a display device and a recording device, and the aforementioned predetermined resolution can be set as the resolution of the display device or can be determined according to the resolution supported by the network bandwidth for transmitting to the image receiving device. The range of the predetermined resolution is not limited, such that the user can adjust the predetermined resolution according to the actual requirement.

First, the image capturing device divides the captured image into multiple unit blocks (step S310), then calculates the image variation of each unit block respectively and marks multiple changed blocks (step S320). Wherein, the steps of marking the changed blocks are: first, the average RGB value of each unit block is calculated respectively; next, at intervals of a predetermined time, the differences of the average RGB values of the unit blocks in two consecutively captured images are compared so as to obtain a R difference, a G difference, and a B difference; then the R difference, G difference, and B difference are compared with a predetermined R tolerance, G tolerance, and B tolerance, and marking the unit block as a changed block when any of the R difference, G difference, and B difference is greater than the R tolerance, G tolerance, and B tolerance.

After all the unit blocks have been compared and marked, the image capturing device selects a focus block to cover all the marked changed blocks (step S330). Several different embodiments are listed below for explaining the method of determining the focus block so that the reader could have better understanding of the present invention.

According to the first embodiment method, an unchanged row in the focus block is deleted when selecting the focus block, and the unchanged row may include multiple unit blocks arranged in a row in the focus block, but does not include any of the marked changed blocks.

According to the second embodiment method, an unchanged column in the focus block is deleted when selecting the focus block, and the unchanged column may include multiple unit blocks arranged in a column in the focus block, but does not include any of the marked changed blocks.

According to the third embodiment method, an unchanged row and an unchanged column in the focus block are deleted together when selecting the focus block, wherein the unchanged row and the unchanged column include multiple unit blocks arranged in a row and in a column in the focus block respectively, but do not include any of the marked changed blocks.

Finally, after the focus block has been selected, the image capturing device adjusts the resolution of the focus block to the predetermined resolution and outputs the focus block to the image receiving device (step S340).

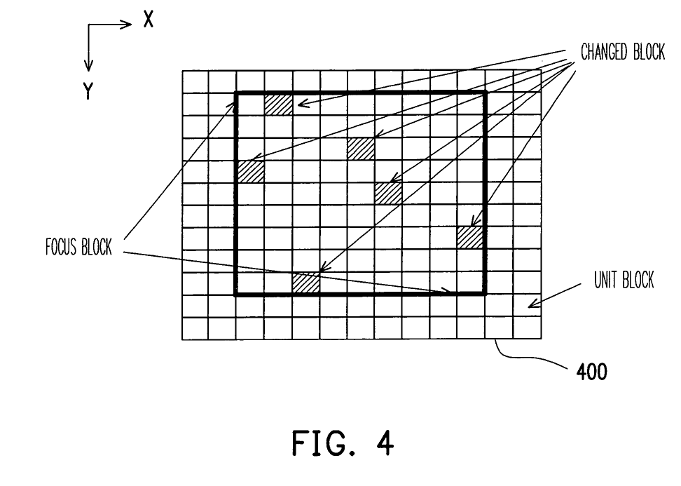

Referring to FIG. 4, in the present embodiment, a captured image 400 having the resolution of 416*384 dpi is divided into 13*12=156 unit blocks of 32*32 dpi. Wherein, the unit blocks with oblique lines represent the marked changed blocks, and the area enclosed with dark border represents the selected focus block.

The calculation method of the focus block in the present embodiment is to define the x and y axis coordinates of all the changed blocks according to their relative positions corresponding to the entire frame first. After that, the maximum and minimum x values of all the changed blocks are defined as the maximum and minimum x values of the focus block respectively, and the maximum and minimum y values of all the changed blocks are defined as the maximum and minimum y values of the focus block respectively, the calculations are expressed by the following formulas:
FocusBlockMinX=Min(all ChangedBlockX)
FocusBlockMinY=Min(all ChangedBlockY)
FocusBlockMaxX=Max(all ChangedBlockX)
FocusBlockMaxY=Max(all ChangedBlockY)

Next, the blocks covered by the focus block are converted into actual image coordinates, and the focus area and zoom ratio of the focus block can be obtained by combining with the predetermined resolution (the block size is defined as BlockWidth*BlockHeight, the coordinate at the top left corner is set to (0,0), and the predetermined resolution is set to TargetWidth*TargetHeight), the computation formulas thereof are as follows:
FocusAreaMinX=(FocusBlockMinX−1)*BlockWidth
FocusAreaMinY=(FocusBlockMinY−1)*BlockWidth
FocusAreaMaxX=FocusBlockMinX*BlockWidth−1
FocusAreaMaxY=FocusBlockMinY*BlockWidth−1
ZoomRatioX=(FocusBlockMaxX−FocusBlockMinX)*BlockWidth/TargetWidth
ZoomRatioY=(FocusBlockMaxY−FocusBlockMinY)*BlockHeight/TargetHeight
As shown in FIG. 4, the present embodiment includes 6 changed blocks, the coordinates thereof are (4,2), (7,4), (3,5), (8,6), (11,8), and (5,10), respectively, and the size of the focus block covered by these changed blocks can be calculated by the following formulas:
MinX=Min(4, 7, 3, 8, 11, 5)=3
MinY=Min(2, 4, 5, 6, 8, 10)=2
MaxX=Max(4, 7, 3, 8, 11, 5)=11
MaxY=Max(2, 4, 5, 6, 8, 10)=10

Accordingly, the region covered by the focus block can be obtained from the calculation as from (3,2) to (11,10), which is from [(3−1)*32, (2−1)*32]=(64,32) to [11*32−1,10*32−1]=(351,319) after being converted into actual pixel coordinates. If the transmission is performed through a video phone with the resolution of 176*144 dpi, the zoom ratio of the image is about (351−64)/176=1.6 times transversely and (319−32)/144=2 times lengthwise. Wherein, if the video phone only supports equal ratio zooming, then the image in the focus block is zoomed with the larger ratio.

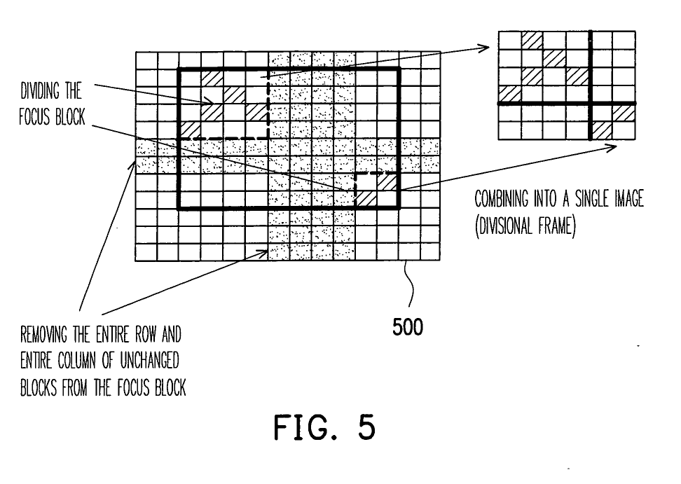

FIG. 5 is a diagram illustrating how to calculate multiple divisional focus blocks according to an embodiment of the present invention. Referring to FIG. 5, in the present embodiment, “entire row” or “entire column” of blocks including no changed blocks (e.g. the dotted unit blocks in FIG. 5) in the focus block of the captured image 500 are removed from the focus block, and the remaining unit blocks are combined into a “divisional frame”, and divisional lines are added to the removed part.

Next, video recording or transmission is performed using the actual coordinates and size of the combined focus blocks. The method of the present embodiment can increase the zoom ratio of the moving region effectively, thus better video quality in recording or transmission can be obtained. As shown in FIG. 5, the columns 6 and 7, and the rows 8, 9, 10, and 11 are all removed and divisional lines are added. After the focus blocks are combined, the zoom ratio of the moving region can be effectively increased to about 40%.

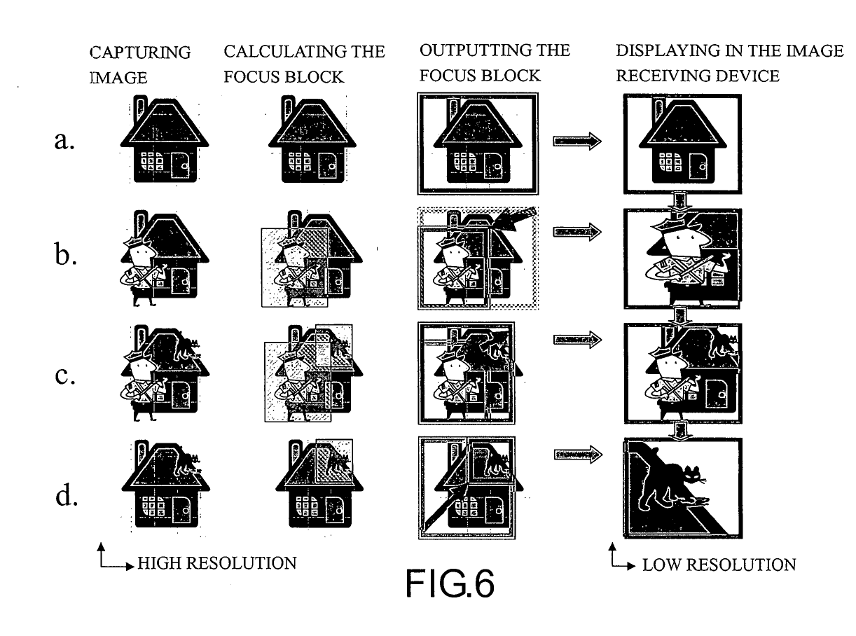

FIG. 6 illustrates an operation example of the apparatus for automatically adjusting monitoring frames based on image variation according to an embodiment of the present invention. Referring to FIG. 6, the present embodiment can be divided into four phases such as capturing image, calculating the focus block, outputting the focus block, and displaying in the image receiving device based on the operation steps, and four images a, b, c, and d based on the situation. The operation flow thereof is as follows:

The original video frame is “a house”. Since there is no moving frame, the focus block is the entire frame, and the output and display of the frame is also the entire frame.

When there is a “person” walking into the frame, the apparatus in the present invention automatically compares frame b with frame a to move the focus block to the image square around the “person”, and outputs the focus block after adjusting the resolution thereof, so as to display the close-up frame of the “person” in the image receiving device.

Next, a “cat” runs into the frame, the apparatus in the present invention automatically compares frame c with frame b to move the focus block to the image square around the “person” and the “cat”, and outputs the focus block after adjusting the resolution thereof so as to display the close-up frame of the “person and cat” in the image receiving device.

After that, the “person” is gone and the “cat” remains. The apparatus in the present invention automatically compares frame d with frame c to move the focus block to the image square around the “cat”, and outputs the focus block after adjusting the resolution thereof so as to display the close-up frame of the “cat” in the image receiving device.

In addition, a delay time can be set to switch the frames smoothly, so that the frames in the image receiving device can be prevented from jumping too fast, which may causes discomfort to the viewer.

In overview, according to the apparatus and method for automatically adjusting monitoring frames based on image variation in the present invention, a changed block judgment device and a regional image output device are added to the image capturing device for automatically locating the corresponding changed blocks when the image is moving or changing, and determining a focus block. The image in the focus block is output to the image receiving device after being adjusted the resolution thereof, thus the purpose of automatically adjusting monitoring frames can be achieved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for automatically adjusting monitoring frames based on image variation, wherein an image is captured by an image capturing device and transmitted to an image receiving device with a predetermined resolution, the method comprising:
the image capturing device dividing the image into a plurality of unit blocks;
the image capturing device calculating the image variation of each unit block respectively, and marking a plurality of changed blocks;
the image capturing device selecting a focus block to cover the plurality of changed blocks; and
the image capturing device adjusting the resolution of the focus block to the predetermined resolution and outputting the focus block to the image receiving device.

2. The method for automatically adjusting monitoring frames as claimed in claim 1, wherein the step of calculating the image variation of each unit block respectively and marking the plurality of changed blocks including:
calculating the average RGB value of each unit block respectively;
at intervals of a predetermined time, comparing the differences of the average RGB values of the unit blocks in the two consecutively captured images so as to obtain an R difference, a G difference, and a B difference, comparing the R difference, G difference, and B difference with a R tolerance, a G tolerance, and a B tolerance respectively; and
marking the unit block as a changed block when any of the R difference, G difference, and B difference being greater than the R tolerance, G tolerance, and the B tolerance.

3. The method for automatically adjusting monitoring frames as claimed in claim 1, wherein the predetermined resolution is determined according to the network bandwidth for transmitting to the image receiving device.

4. The method for automatically adjusting monitoring frames as claimed in claim 1, wherein the image receiving device is a display device.

5. The method for automatically adjusting monitoring frames as claimed in claim 4, wherein the predetermined resolution is the resolution of the display device.

6. The method for automatically adjusting monitoring frames as claimed in claim 1, wherein the image receiving device is a recording device.

7. The method for automatically adjusting monitoring frames as claimed in claim 1, wherein an unchanged row in the focus block is further deleted when selecting the focus block, wherein the unchanged row includes a plurality of unit blocks arranged in a row in the focus block and does not include any of the aforementioned changed blocks.

8. The method for automatically adjusting monitoring frames as claimed in claim 1, wherein an unchanged column in the focus block is further deleted when selecting the focus block, wherein the unchanged column includes a plurality of unit blocks arranged in a column in the focus block and does not include any of the aforementioned changed blocks.

9. The method for automatically adjusting monitoring frames as claimed in claim 1, wherein an unchanged row and an unchanged column in the focus block are further deleted when selecting the focus block, wherein the unchanged row and the unchanged column include a plurality of unit blocks arranged in a row and in a column in the focus block respectively and do not include any of the aforementioned changed blocks.

10. An apparatus for automatically adjusting monitoring frames based on image variation, comprising:
an image capturing device, used for capturing an image;
an image receiving device, used for receiving the image captured by the image capturing device;
a changed block judgment device, disposed in the image capturing device and used for dividing the image into a plurality of unit blocks, calculating the image variation of each unit block respectively, and marking a plurality of changed blocks; and
a regional image output device, disposed in the image capturing device and used for determining a focus block based on the plurality of changed blocks to cover the plurality of changed blocks and transmitting the focus block to the image receiving device with a predetermined resolution.

11. The apparatus for automatically adjusting monitoring frames as claimed in claim 10, wherein the changed block judgment device calculates the average RGB value of each unit block respectively, at intervals of a predetermined time compares the differences of the average RGB values of the unit blocks in the two consecutively captured images so as to obtain a R difference, a G difference, and a B difference, and compares the R difference, G difference, and B difference with a predetermined R tolerance, G tolerance, and B tolerance, and marks the unit block as a changed block when any of the R difference, G difference, and B difference is greater than the R tolerance, G tolerance, and B tolerance.

12. The apparatus for automatically adjusting monitoring frames as claimed in claim 10, wherein the regional image output device further deletes an unchanged row in the focus block when the regional image output device is determining the focus block, wherein the unchanged row includes a plurality of unit blocks arranged in a row in the focus block and does not include any of the aforementioned changed blocks.

13. The apparatus for automatically adjusting monitoring frames as claimed in claim 8, wherein the focus block marking device further deletes an unchanged column in the focus block when the focus block marking device is selecting the focus block, wherein the unchanged column includes a plurality of unit blocks arranged in a column in the focus block and does not include any of the aforementioned changed blocks.

14. The apparatus for automatically adjusting monitoring frames as claimed in claim 8, wherein the focus block marking device further deletes an unchanged row and an unchanged column in the focus block when the focus block marking device is selecting the focus block, wherein the unchanged row and the unchanged column include a plurality of unit blocks arranged in a row and in a column in the focus block and do not include any of the aforementioned changed blocks.
